(19) United States
(12) Patent Application Publication
(10) Pub. No.: US 2015/0148206 A1
(43) Pub. Date: May 28, 2015

(54) ROLLER, AND METHOD FOR MANUFACTURING THE SAME

(71) Applicant: VOITH PATENT GMBH, HEIDENHEIM (DE)

(72) Inventors: Hubert Bischof, Muerzzuschlag (AT); Martin Breineder, Natschbach (AT); Franz Grohmann, Payerbach (AT)

(73) Assignee: VOITH PATENT GMBH, HEIDENHEIM (DE)

(21) Appl. No.: 14/397,251

(22) PCT Filed: Apr. 11, 2013
(86) PCT No.: PCT/EP2013/057572

§ 371 Date: Oct. 27, 2014

(30) Foreign Application Priority Data
Apr. 27, 2012 (DE) 102012207095.8

(51) Int. Cl. D21G 1/02; B32B 38/08; B32B 37/14

(52) U.S. Cl. CPC D21G 1/02; B32B 37/142; B32B 38/08
USPC 492/20; 156/185; 492/28; 492/53

(57) ABSTRACT

A roller is particularly suited for use in a machine for manufacturing and/or finishing a fibrous web, such as a paper web or cardboard web. The roller includes a roller core and, configured thereon, a roller covering. The covering has at least one layer of a resin material with at least one fiber material embedded therein. The at least one layer has an outer surface that is suitable for coming into direct or indirect contact with the fibrous web. The at least one fiber material here comprises fibers having a linear weight from 0.5 to 5 dtex, preferably from 0.5 to 2 dtex.

The invention relates to a roller, in particular for use in a machine for manufacturing and/or finishing a fibrous web, such as, for example, a paper web or cardboard web, according to the preamble of claim 1, and a method for manufacturing a roller of this type, according to claim 7.

The use of fiber-reinforced and filled epoxy resins for roller coverings in calenders, and for other abrasion-resistant roller coverings for application in the paper industry and for similar applications, constitutes the prior art.

For example, a fiber-composite roller covering for employment in machines processing two-dimensional material is known from DE 102004025116A, wherein the material of the roller covering displays a fiber component and a matrix component and wherein the material composition, consisting of fiber component and matrix component, continuously varies at least in sections.

Furthermore, a roller, in particular for a calender, which displays a roller body of a metallic material and, thereon, an elastic roller covering which comprises at least three layers which display a polymer matrix and fiber reinforcements, is disclosed in WO 008/116832 A. One of the layers here comprises at least 25% carbon fibers.

The known roller coverings usually contain a certain proportion of filler materials which determine the technical properties of the coverings and, in particular here, the compressive modulus and the resistance to abrasion. In order to achieve the desired properties, filler ratios of up to 30% by volume are not uncommon. However, in many positions with high loading, filling with filling-material particles cannot guarantee the desired mechanical and/or thermal durability of the roller coverings in relation to reduction of thermal expansion, of mechanical expansion behavior and of strength.

It is, therefore, an object of the invention to provide measures which enable an improvement of the last-mentioned properties.

The object is achieved in respect of the roller by the characterizing features of claim 1 and in respect of the method by the characterizing features of claim 7, in each case in conjunction with the generic features.

It is provided here, according to the invention, that a roller covering which is highly resilient to thermal and/or mechanical load is created by using suitable fibers which display a linear weight from 0.5 to 5 dtex, preferably from 0.5 to 2 dtex.

Further advantageous embodiments and aspects of the invention are derived from the dependent claims.

The fiber content in the roller covering advantageously may be 15 to 25% by weight.

According to an advantageous aspect of the invention, the at least one fiber material may be a blend of fibers of different lengths and/or of different linear weights and/or of different materials.

The at least one fiber material preferably may be a blend of fibers of various aramid types or a blend of mixtures of aramid and polyester, polyacrylonitrile or viscose.

The at least one fiber material advantageously may be present in the form of a random-fiber non-woven material.

The roller covering may contain at least one filler material which is selected from: oxides, carbides, nitrates, (aluminum) silicates, sulfates, carbonates, phosphates, titanates, carbon nano tubes, carbon nano fibers, glass spheres, metals (with or without surface modification) of mineral or synthetic origin.

A method for manufacturing a roller configured in such a manner, according to the invention, may comprise the following steps: preparing a roller body, providing a tape-type fiber material and a resin material, wrapping the tape-type fiber material onto the rotating roller body by means of a controlled tension and/or under defined elongation of the fiber material, impregnating the tape-type fiber material with resin material and curing the roller covering.

According to an advantageous aspect of the invention, the step of impregnating the tape-type fiber material with resin material may take place prior to and/or during and/or after wrapping the tape-type fiber material onto the roller body.

Wrapping of the tape-type fiber material may advantageously take place in a plurality of strokes across a plurality of layers or in one stroke across one layer having mutually overlapping wrappings.

The invention will be described in more detail below, with reference to the figures. In the figures:

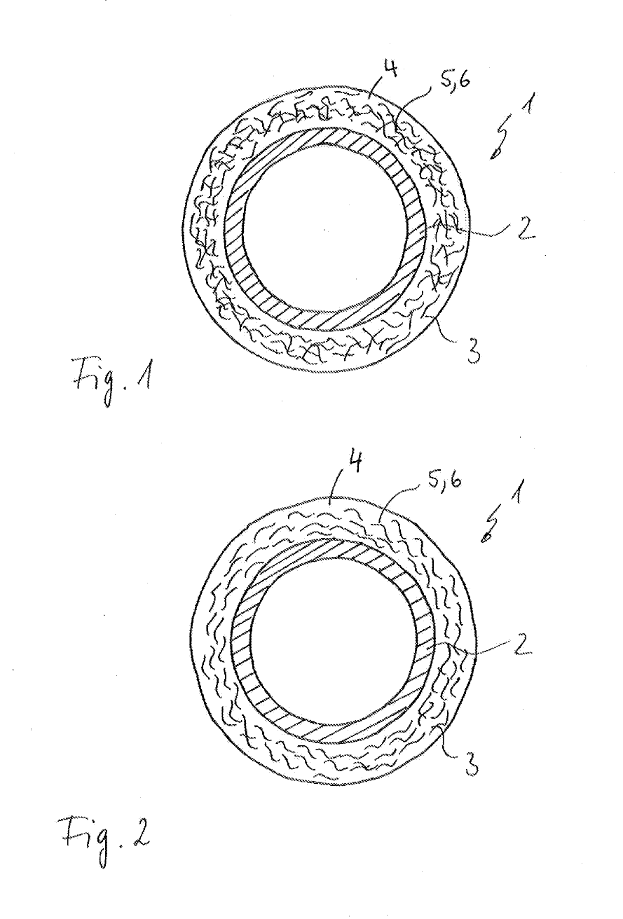

FIG. 1 shows a very schematic sectional illustration of a roller covering designed according to the invention, according to a first exemplary embodiment, and

FIG. 2 shows a very schematic sectional illustration of a roller covering designed according to the invention, according to a second exemplary embodiment.

In FIGS. 1 and 2 two exemplary embodiments for rollers 1 which are suitable for example for use in a polishing stack or a calender for finishing a fibrous web, such as, for example, a paper web or cardboard web, for the purpose of highlighting the inventive measures are illustrated in a very schematic sectional illustration.

Rollers 1 of this type must be able to withstand both, high line loads and also high temperatures. In established types of calender construction which can be operated directly in-line in a paper machine or also off-line as stand-alone assemblies, one or more elastic rollers 1 can in each case with at least one hard roller (not illustrated further) form a nip in which the fibrous web passing through is polished and satin-finished.

The rollers 1 here usually display a hard roller core 2 which is preferably made from a metallic material, such as steel. In the meantime, as an alternative thereto, roller cores 2 from fiber-reinforced plastics have also become known.

On the roller core 2 a roller covering 3, which in the described exemplary embodiments is formed from a resin material 4 which usually comprises a combination of one or more resin components and a curing agent and, if applicable, further additives and auxiliary materials, is configured. A multiplicity of epoxy resins, isocyanate esters or other duroplastics, which are aminically or anhydrously cross-linked, or also are self-cross-linking are available here as resin components.

Usually, filler material components which are contained in the resin material 4 and/or are introduced into the fiber material 5 and/or, during the wrapping process, are applied onto the fiber material 5 which has already been impregnated with resin material 4 and/or onto a surface of the rotating roller 1 are used. As filler materials, hard materials such as oxides, carbides, nitrates, (aluminum) silicates of mineral or synthetic origin, or glass spheres, and/or nano-scale filler materials such as those already mentioned above, but also sulfates, carbonates, phosphates, titanates, carbon nano tubes, carbon nano fibers, or metals with or without surface modifications may be considered.

The known roller coverings 2, as already indicated above, furthermore usually display armoring or reinforcing made from one or more fiber components. In FIGS. 1 and 2, the fiber material 5, in order to better highlight the inventive measures, is illustrated in a heavily schematic manner in the form of individual fiber pieces 6.

On account of their high strength, aramid fibers, but also polyester, polyacrylonitrile or viscose are primarily employed, which fibers, for example, in a wrapping process are applied in the form of tape-type random-fiber non-woven materials onto the roller 1 and hereby and/or prior to and//or thereafter are impregnated with the resin material 4, or a precursor thereof, which, after curing with or without the addition of further components, results in a composite material. The wrapping process will be discussed separately in even more detail below.

The proportion of fiber material 5 in relation to the entire composite material, and the average alignment of individual fiber pieces 6 in the various directions of alignment greatly influence the properties of the final composite, such as, for example, strengths and thermal expansion.

In order to achieve properties which are as uniform as possible in all spatial directions of the roller covering 2 and/or to achieve a targeted graduation in the various spatial directions, a certain distribution of the fiber pieces 6 in the various spatial directions is required. Alignment is achieved, on the one hand, by the distribution which is already present in the random-fiber non-woven material. In the case of materials manufactured in what is referred to as a wet-laced process, said alignment is substantially two-dimensional, and substantially three-dimensional in the case of materials which have been manufactured in a spun-laced process. The mentioned manufacturing processes will not be discussed in more detail here, since they are known from the prior art to a person skilled in the relevant art.

Alignment of the fiber pieces 6, on the other hand, is also determined by the orientation of the fibers which arises under tension during the wrapping process in substantially the circumferential direction of the roller. The extent of orientation, in particular in the case of materials which have been manufactured in the spun-laced process, depends primarily on the dimensional stability of the random-fiber non-woven material under tension. Apart from the orientation, the dimensional change of the random-fiber non-woven material also plays a significant role in the wrapping process itself, since a constant width and thickness of the material are essential for a precise wrapping process.

It can be seen in FIG. 1 that the fiber pieces 6 are oriented in all spatial directions, with, however, comparatively many fiber pieces 6 being present, while in FIG. 2 the orientation of the fiber pieces 6 substantially follows the wrapping direction, the number of fiber pieces 6, however, being fewer.

By way of combining various fiber diameters, preferably in the range from 0.5 to 5 dtex, and the use of fibers which tend to be finer, particularly preferably in the range of 0.5 to 2 dtex, the dimensional stability of the random-fiber non-woven material can be increased. On account thereof it is possible to achieve fiber contents in the composite material that are higher by 50% to 100%, since the wrapping process can be carried out at a tension which is higher by at least 200%, without causing an irregular dimensional change in the random-fiber non-woven material during the wrapping operation, or impermissibly high orientation of the fibers during the wrapping process. On account of the higher tension during the wrapping process a significantly increased fiber content of 15 to 25% by weight results, instead of 10 to 15% by weight which can be achieved with conventional material.

As suggested by test-bed experiments, coverings manufactured in this manner, when employed in calenders, may display a permissible line load which is up to 20% higher and, in the case of local overloading, display a significantly higher resistance to damage.

The wrapping methods which may serve in the manufacturing of roller coverings 2 of this type are essentially known per se, but they differ from the conventional methods in that, as already mentioned earlier, they are carried out a wrapping tension which is up to 200% higher. The web-shaped fiber material 5 is usually wrapped onto the rotating roller body 2 and prior to and/or during and/or after the wrapping process onto a roller body is impregnated with the matrix material 4. Wrapping here may take place by way of a plurality of strokes and in a plurality of layers, one on top of the other, but may also take place in only one layer, wherein the individual wrappings may overlap in an imbricate manner. The overlapping regions here may be 45% or more of the width of the web-type fiber material 5.

An adhesive layer and/or a base layer which may serve in bonding of the roller covering 3 on the roller core 2 are/is usually located between the roller core 2 and the roller covering 3. For reasons of clarity, a detailed illustration of these adhesion-promoting layers has been dispensed with in the figures.

1-9. (canceled)

10. A roller for a machine for processing a fibrous web, comprising:
a roller core;
a roller covering disposed on said roller core;
said roller covering having at least one layer of a resin material with a fiber material embedded therein, said at least one layer having an outer surface suitably configured for (direct or indirect) contact with the fibrous web;
said fiber material including fibers having a linear weight from 0.5 to 5 dtex.

11. The roller according to claim 10, wherein the linear weight of said fibers lies between 0.5 and 2 dtex.

12. The roller according to claim 10, configured for a machine for manufacturing and/or finishing the fibrous web being a paper web or cardboard web.

13. The roller according to claim 10, wherein a content of said fiber material in said at least one layer is 15 to 25% by weight.

14. The roller according to claim 10, wherein said fiber material is a blend of fibers selected from the group of fibers having different lengths, fibers having different linear weights, and fibers of different materials.

15. The roller according to claim 10, wherein said fiber material is a blend of fibers of various aramid types.

16. The roller according to claim 10, wherein said fiber material is a blend of mixtures of aramid and polyester, aramid and polyacrylonitrile, or aramid and viscose.

17. The roller according to claim 10, wherein said fiber material is a random-fiber non-woven material.

18. The roller according to claim 10, wherein said roller covering contains at least one filler material selected from the group consisting of oxides, carbides, nitrates, silicates, sulfates, carbonates, phosphates, titanates, carbon nano tubes, carbon nano fibers, glass spheres, and metals of mineral or synthetic origin.

19. The roller according to claim 18, wherein said filler material is aluminum silicate or metals with or without surface modification.

20. A method of manufacturing a roller, the method comprising the following steps: preparing a roller body;
providing a tape of fiber material and a resin material;
rotating the roller body and wrapping the tape of fiber material onto the rotating roller body under controlled tension and/or under a defined elongation of the fiber material; and
impregnating the tape of fiber material with the resin material and curing to form a roller covering on a roller.

21. The method according to claim 20, which comprises carrying out the step of impregnating the tape-shaped fiber material with resin material prior to and/or during and/or after wrapping the tape-shaped fiber material onto the roller body.

22. The method according to claim 20, which comprising wrapping the tape-shaped fiber material in a plurality of strokes across a plurality of layers or in one stroke across one layer having mutually overlapping wrappings.
